(19) United States
(12) Patent Application Publication
(10) Pub. No.: US 2025/0371208 A1
(43) Pub. Date: Dec. 4, 2025

(54) Joint Modeling and Simulation Method and System for Ocean Engineering Installation Operation

(71) Applicant: Harbin Engineering University, Harbin (CN)

(72) Inventors: Yingfei ZAN, Harbin (CN); Zhongming Li, Harbin (CN); Lihan Yuan, Harbin (CN); Chuanyue Xu, Harbin (CN); Ruinan Guo, Harbin (CN); Haitao Zhu, Harbin (CN); Zhiheng Miao, Harbin (CN); Duanfeng Han, Harbin (CN)

(21) Appl. No.: 19/297,027

(22) Filed: Aug. 12, 2025

Related U.S. Application Data
(63) Continuation of application No. PCT/CN2025/078398, filed on Feb. 21, 2025.

(30) Foreign Application Priority Data
Jun. 21, 2024 (CN) 202410806427.4

(51) Int. Cl. G06F 30/13; G06F 111/02; G06F 111/10

(52) U.S. Cl. CPC G06F 30/13; G06F 2111/02; G06F 2111/10

(57) ABSTRACT

Disclosed is a joint modeling and simulation method and system for ocean engineering installation operation, belongs to the technical field of ship and ocean engineering, and particularly relates to joint modeling and simulation for ocean engineering installation operation. The problems of low simulation efficiency, incapability of satisfying real-time requirements of engineering drills, and high time cost caused by repeated development due to difficulty in reuse of a simulation model in the ocean engineering equipment installation operation at present are solved. The method includes the following steps: step S1: acquiring an equipment independent motion simulation model; and step S2: acquiring joint simulation real-time data through motion transmission simulation and load transmission simulation. The joint modeling and simulation method and system for ocean engineering installation operation are applicable to the joint modeling and simulation for ocean engineering installation operation.

### TECHNICAL FIELD

The disclosure herein relates to the technical field of ship and ocean engineering, and particularly relates to joint modeling and simulation for ocean engineering installation operation.

### BACKGROUND

The installation of a large-scale deep-water structure (i.e., ocean engineering equipment installation operation), as a key link of deep-sea energy development, requires cooperative construction operation by a plurality of pieces of equipment. The types of water surface or underwater operation equipment involved are complex. In addition, there are operation stations, and the operation environment is harsh. It has the characteristics of high difficulty, high technology, high investment and high risk. Through a digital modeling and simulation technology, the motion response and construction operation process of a multi-body coupling system installed at sea is simulated, and construction plan drills and personnel training are performed. The construction risks in the installation process of the large-scale deep-water structure can be effectively reduced, and the safety of equipment and operation personnel can be further guaranteed.

However, existing ocean engineering equipment installation operation modeling and simulation technologies are generally oriented to the multi-equipment cooperative operation scene at sea. Combination equations of a multi-body system are established through extensive derivations, and the required equipment is subjected to integrated solution and analysis. The integrated solution and analysis need a huge computation amount and complicated calculation processes. This leads to the low simulation efficiency and incapability of meeting the real-time requirements of the engineering drills of the existing modeling and simulation technologies. At the same time, the existing modeling and simulation technologies are not highly operable in an aspect of simulation model design and function configuration, is not favorable for simulation model use, and is high in time cost for repeated development.

### SUMMARY

The disclosure provides a joint modeling and simulation method and system for ocean engineering installation operation, and solves the problems of low simulation efficiency, incapability of satisfying real-time requirements of engineering drills, and high time cost caused by repeated development due to difficulty in reuse of a simulation model in the ocean engineering equipment installation operation at present.

The joint modeling and simulation method for ocean engineering installation operation provided by the disclosure has the following technical solution:

The method includes the following steps:
step S1: acquiring an equipment independent motion simulation model by calculating and loading a load acting on each piece of equipment according to an installation operation simulation scene; and
step S2: in given simulation time, acquiring joint simulation real-time data by using an iteration manner according to the equipment independent motion simulation model, wherein in each iteration, a simulation step size for time advancing is set as dtSC, a solution step size for solving each piece of equipment is set as dtIC, the simulation step size and the solution step size meet dtSC≥dtIC, a multiple relationship between the simulation step size and the solution step size is an integral multiple relationship, or if not an integer multiple relationship, rounded up, the multiple relationship of the simulation step size and the solution step size is used as a number n of iteration steps in a single simulation step size, and n>0; and each iteration includes the following steps:
step S2.1: setting global simulation time of this iteration to be t, and updating a position of a connection node each piece of equipment at time t through motion transmission simulation;
step S2.2, using connection nodes after position updating as boundary conditions in load transmission simulation, and acquiring an environment load of each piece of equipment and a load acting force and a force moment of accessory equipment through load transmission simulation;
step S2.3: substituting the environment load of each piece of equipment and the load acting force and the force moment of the accessory equipment into the equipment independent motion simulation model to acquire a resultant force acting on each piece of equipment at the time t in combination with a hydrodynamic and static force acting on each piece of equipment itself;
step S2.4: in the simulation step size dtSC, acquiring an acceleration of the equipment by classifying the resultant force acting on each piece of equipment at the time t by a mass and inertia moment of each piece of equipment as well as an additional mass and additional inertia moment; and
performing n integration solution by a Runge-Kutta method according to the solution step size dtIC to acquire the joint simulation real-time data of each piece of equipment at time t, wherein the joint simulation real-time data includes motion of each piece of equipment and a load of the auxiliary equipment;
step S2.5: judging whether the iteration is complete:
if the iteration is not complete, updating the simulation time according to t=t+dtSC, and continuously performing a next iteration; and
otherwise, the iteration is complete, ending the simulation method.

Further, an exemplary implementation is provided, and step S1 includes the following steps:
step S1.1: building an installation simulation basic mathematical model of each piece of equipment according to the installation operation simulation scene,

$${\dot{v}}_{i} = \frac{{τ}_{i}}{( {M}_{i} + {M}_{Ai} )}$$

wherein i represents a serial number of the equipment, i∈[1,N], and N is a positive integer; Mᵢ is a mass and inertia moment of the i^{th} equipment; M_{Ai} is an additional mass and additional inertia moment of the i^{th} equipment; τᵢ is a resultant force acting on the i^{th} equipment, \dot{v}_{i=l, n} is a motion acceleration of the i^{th} equipment; and
through integral iteration, acquiring a motion speed vᵢ and a pose xᵢ of the i^{th} equipment;
step S1.2: calculating the resultant force acting on the i^{th} equipment:

$${τ}_{i} = {\underbrace{{F}_{{HydroStat}_{i}}}}_{Hydrodynamic and static force} + {\underbrace{{F}_{{Wind}_{i}} + {F}_{Curren {t}_{i}} + {F}_{{Wave}_{i}}}}_{Environment acting force} + {\underbrace{{F}_{{Line}_{i}}}}_{Rope acting force} + {\underbrace{{F}_{othe {r}_{i}}}}_{Other external force} ,$$

wherein
F_{Wind} _{ᵢ} is a wind load acting on the i^{th} equipment, F_{Current}_{ᵢ} is a current load acting on the i^{th} equipment, and F_{Wave} _{ᵢ} is a wave load acting on the i^{th} equipment; and
step S1.3: acquiring the equipment independent motion simulation model according to the installation simulation basic mathematical model of each piece of equipment and the resultant force acting thereon.

Further, an exemplary implementation is provided. In step S1.2, if the i^{th} equipment is a hanging rope or an anchor cable formed by lumped mass nodes, the resultant force acting thereon is acquired by the following method:
respectively modeling the hanging ropes and anchor cables of different materials, and regarding the resultant force acting on each node as τₑ_{_{i,j}}:

$${τ}_{{c}_{l , i}} = {\underbrace{{T}_{{l}_{j + ( 1 / 2 )}} - {T}_{{l}_{j - ( 1 / 2 )}} + {C}_{{l}_{j + ( 1 / 2 )}} - {C}_{{l}_{j - ( 1 / 2 )}} + {F}_{m {l}_{j}}}}_{Internal force of node} + {\underbrace{{D}_{p {l}_{j}} + {D}_{q {l}_{j}} + {W}_{{l}_{j}} + {B}_{{l}_{j}}}}_{Hydrodynamic and static force of node} + {\underbrace{{F}_{other {l}_{j}}}}_{Other external force} ,$$

wherein
a subscript l represents a serial number of a hanging rope or an anchor cable, l∈[1,f], and f is a total number of the hanging ropes or anchor cables; j represents a serial number of lumped mass nodes in the l^{th} hanging rope or anchor cable, it is supposed that each hanging rope or anchor cable consists of m segments of cables, each hanging rope or anchor cable includes m+1 lumped mass nodes, and j∈[1,m]; Tₗ_{_{j+(1/2)}} is a tension of a [j+(½)]^{th} segment of the l^{th} hanging rope or anchor cable; Tₗ_{_{j−(1/2)}} is a tension of the [j−(½)]^{th} segment of the l^{th} hanging rope or anchor cable; Cₗ_{_{j+(1/2)}} is an internal damping force of the [j+(½)]^{th} segment of the l^{th} hanging rope or anchor cable; Cₗ_{_{j−(1/2)}} is an internal damping force of the [j−(½)]^{th} segment of the l^{th} hanging rope or anchor cable; Fₘₗ_{ⱼ} is a bending moment acting force of the j^{th} lumped mass node of the l^{th} hanging rope or anchor cable; Dₚₗ_{ⱼ} is a transverse resistance force of the l^{th} hanging rope or anchor cable at the j^{th} lumped mass node; D_{ql}_{ⱼ} is a tangential resistance force of the l^{th} hanging rope or anchor cable at the j^{th} lumped mass node; Fₒₜₕₑᵣₗ_{ⱼ} is other external force acting on the j^{th} lumped mass node of the l^{th} hanging rope or anchor cable;

$${T}_{{l}_{j + ( 1 / 2 )}} = {E}_{l} \frac{π}{4} {d}_{l}^{2} ( \frac{1}{{L}_{{l}_{j}}} - \frac{1}{‖ {r}_{{l}_{j + 1}} - {r}_{{l}_{j}} ‖} ) ( {r}_{{l}_{j + 1}} - {r}_{{l}_{j}} ) ,$$

where Eₗ is a stiffness of the l^{th} hanging rope or anchor cable, dₗ is a diameter of the l^{th} hanging rope or anchor cable, Lₗ_{ⱼ} is a segment length of the j^{th} lumped mass node of the l^{th} hanging rope or anchor cable, and rₗ_{ⱼ₊₁} and rₗ_{ⱼ} are coordinates of the (j+1)^{th} and j^{th} lumped mass nodes of the l^{th} hanging rope or anchor cable;

$${C}_{{l}_{j + ( 1 / 2 )}} = {C}_{int l} \frac{π}{4} {d}_{l}^{2} {\dot{ε}}_{{l}_{j + ( 1 / 2 )}} ( \frac{{r}_{{l}_{j + 1}} - {r}_{{l}_{j}}}{‖ {r}_{{l}_{j + 1}} - {r}_{{l}_{j}} ‖} ) ,$$

wherein Cᵢₙₜₗ is an internal damping coefficient of the l^{th} hanging rope or anchor cable, and \dot{ε}ₗ_{_{j+(1/2)}} is a strain rate; and

$${F}_{{ml}_{j}} = \frac{{EI}_{l} {k}_{{l}_{j}}}{{dl}_{{l}_{j}}} ,$$

wherein EIₗ is a bending stiffness of the l^{th} hanging rope or anchor cable; and kₗ_{ⱼ} is a curvature in a rₗ_{ⱼ} position, and dlₗ_{ⱼ} is a segment stretched length of the j^{th} lumped mass node of the l^{th} hanging rope or anchor cable.

Further, an exemplary implementation is provided, and step S2.1 includes the following steps:
step S2.1.1: classifying equipment in the installation operation simulation scene into a transmission main body and auxiliary equipment, and determining connection nodes between the auxiliary equipment and the transmission main body; classifying the connection nodes into nodes directly moving along with the transmission main body, and nodes restrained by an equipment operation range for indirectly moving along with the transmission main body;
step S2.1.2: for the nodes directly moving along with the transmission main body:
calculating and updating the positions of the nodes in accordance with a Euler angle, a rotation sequence and an external rotation manner according to the motion of the transmission main body at the time t to acquire the positions of the nodes directly moving along with the transmission main body at the time t; and
step S2.1.3: for the nodes restrained by an equipment operation range for indirectly moving along with the transmission main body:
calculating and updating the positions of the nodes relative to a gravity center of the transmission main body at the time t through calculation according to a D-H parameter method without considering the motion of the transmission main body at the time t but only considering the restraint on the nodes by the equipment operation range; and
calculating and updating the positions of the nodes according to the positions of the nodes relative to the gravity center of the transmission main body at the time t in accordance with the Euler angle, the rotation sequence, the external rotation manner, and the motion of the transmission main body at the time t to acquire the positions of the nodes restrained by an equipment operation range for indirectly moving along with the transmission main body at the time t.

Further, an exemplary implementation is provided, and step S2.3 includes the following steps:
step S2.3.1: classifying the load transmission simulation into environment load transmission and accessory equipment load transmission;
step S2.3.2: for the environment load transmission:
acquiring environment load acting forces and force moments acting along an x-axis, a y-axis and a z-axis of a body-fixed coordinate system at the gravity center of the transmission main body according to the hydrodynamic characteristics of the transmission main body and the six-freedom-degree motion calculation of the transmission main body; and
step S2.3.3: for the auxiliary equipment load transmission:
using connection nodes after position updating as boundary conditions;
acquiring an acting force of the connection nodes relative to the gravity center of the transmission main body, and positions of the connection nodes relative to the gravity center of the transmission main body according to the equipment independent motion simulation model; and
multiplying the acting force of the connection nodes relative to the gravity center of the transmission main body and the positions of the connection nodes relative to the gravity center of the transmission main body to acquire the load acting force and the force moment of the auxiliary equipment acting along the x-axis, the y-axis and the z-axis of the body-fixed coordinate system at the gravity center of the transmission main body.

The disclosure further provides a joint modeling and simulation system for ocean engineering installation operation, and the system adopts the following technical solution:
The system includes: a cooperative operation equipment configuration and motion simulation platform, an ocean engineering installation operation cooperative simulation platform, a simulation support platform and a plurality of simulation stations;
the ocean engineering installation operation cooperative simulation platform includes a distributive cooperative simulation core framework; the distributive cooperative simulation core framework, as a central control node, is connected with the plurality of simulation stations through network communication, and is configured to provide a data communication interface and resource allocation and scheduling according to the installation operation simulation scene and control a simulation progress;
each simulation station is used as a distributive node and is configured to provide semi-physical simulation equipment;
the cooperative operation equipment configuration and motion simulation platform is configured to provide an equipment installation operation joint simulation model framework applicable to a floating structure, a rod member structure and a hanging rope and anchor cable consisting of lumped mass nodes;
the equipment installation operation joint simulation model framework is configured to build an equipment independent motion simulation model according to an equipment type in the installation operation simulation scene by using the above joint modeling and simulation method for ocean engineering installation operation, perform integrated simulation through motion transmission and load transmission, and reuse and share the equipment independent motion simulation model to acquire joint simulation real-time data; and
the simulation support platform is configured to be connected with the simulation stations required by the installation operation simulation scene according to the data communication interface and resource allocation and scheduling provided by the ocean engineering installation operation cooperative simulation platform, and call the required semi-physical simulation equipment and the equipment independent motion simulation model to complete the simulation in the installation operation simulation scene.

Further, an exemplary implementation is provided, and the system further includes a visual simulation platform;
the visual simulation platform includes a two-dimensional data visual module and a three-dimensional model visual module;
the three-dimensional model visual module is configured to receive the joint simulation real-time data generated by the cooperative operation equipment configuration and motion simulation platform according to the data communication interface and resource allocation and scheduling provided by the ocean engineering installation operation cooperative simulation platform, and drive a three-dimensional model in a visual three-dimensional image to run according to the joint simulation real-time data; and
the two-dimensional data visual module is configured to receive the joint simulation real-time data generated by the cooperative operation equipment configuration and motion simulation platform according to the data communication interface and resource allocation and scheduling provided by the ocean engineering installation operation cooperative simulation platform, and display the joint simulation real-time data into a two-dimensional data curve in a visual two-dimensional image.

Further, an exemplary implementation is provided, and the plurality of simulation stations include a floating type equipment installation simulation station, an installation ship simulation station, a jacket installation simulation station, an underwater robot simulation station, a dome screen view simulation station and a crane simulation station.

Further, an exemplary implementation is provided, and the simulation support platform includes a construction drill module and a personnel training module;
the construction drill module is configured to be connected with the simulation stations required by the construction drill simulation scene according to the data communication interface and resource allocation and scheduling provided by the ocean engineering installation operation cooperative simulation platform, and call the required semi-physical simulation equipment and the equipment independent motion simulation model to complete the simulation in the construction drill simulation scene; and
the personnel training module is configured to be connected with the simulation stations required by the personnel training simulation scene according to the data communication interface and resource allocation and scheduling provided by the ocean engineering installation operation cooperative simulation platform, and call the required semi-physical simulation equipment and the equipment independent motion simulation model to complete the simulation in the personnel training simulation scene.

Further, an exemplary implementation is provided, and the simulation support platform further includes a data storage module; and
the data storage module is configured to store the joint simulation real-time data generated by the cooperative operation equipment configuration and motion simulation platform according to the data communication interface and resource allocation and scheduling provided by the ocean engineering installation operation cooperative simulation platform.

The disclosure has the following beneficial effects:

1. According to the joint modeling and simulation method for ocean engineering installation operation of the disclosure, each piece of cooperative simulation equipment is subjected to independent model and unified integrated simulation, so the calculation is simplified, the simulation efficiency is improved, and the real-time requirement of the engineering drills may be satisfied.

2. According to the joint modeling and simulation system for ocean engineering installation operation of the disclosure, different simulation stations are selected and planed in accordance with different installation operation simulation requirements, different equipment loads are calculated and loaded, the reuse and sharing of the equipment independent motion simulation model are realized, the application range of the simulation system is effectively expanded, and the reusability and operability of the system are enhanced.

3. According to the joint modeling and simulation system for ocean engineering installation operation of the disclosure, a distributive method is adopted for building the ocean engineering installation operation cooperative simulation platform, the simulation stations required for different ocean engineering installation operation scenes may be subjected to organization management and resource coordination (i.e., resource allocation and scheduling) as independent simulation nodes, that is, different simulation stations are selected and planed according to different installation operation simulation requirements, different equipment loads are calculated and loaded, the reuse and sharing of the equipment independent motion simulation model are realized, the application range of the simulation system is effectively expanded, and the reusability and operability of the system are enhanced.

4. According to the joint modeling and simulation system for ocean engineering installation operation of the disclosure, through the cooperative operation equipment configuration and motion simulation platform, the independent modeling on each piece of cooperative simulation equipment is supported, it is deployed to different computers, the integrated simulation is performed through a coupling relationship (i.e., motion transmission and load transmission) between the equipment, the reuse and sharing of the equipment independent motion simulation model are realized, and the system execution efficiency is improved on while ensuring the simulation precision.

The joint modeling and simulation method and system for ocean engineering installation operation provided by the disclosure are applicable to the joint modeling and simulation for ocean engineering installation operation.

### BRIEF DESCRIPTION OF FIGURES

In order to describe the technical solution of implementations of the disclosure more clearly, drawings to be used in implementations are briefly introduced. Obviously, drawings described hereafter are only some implementations of the disclosure. For a person of ordinary skill in the art, other drawings may also be obtained according to these drawings without any inventive efforts.

FIG. 1 is a flow chart of a joint modeling and simulation method for ocean engineering installation operation in an implementation of the disclosure.

FIG. 2 is a schematic structure diagram of a joint modeling and simulation system for ocean engineering installation operation in an implementation of the disclosure.

FIG. 3 is a flow chart of method for building an equipment independent motion simulation model of a joint modeling and simulation system for ocean engineering installation operation in an implementation of the disclosure.

FIG. 4 is a schematic three-dimensional visual diagram of in a jacket skirt pile double-ship joint lifting installation operation simulation scene in an implementation of the disclosure.

FIG. 5 is a is a schematic diagram of two-dimensional data curves of accessory equipment loads of equipment in a jacket skirt pile double-ship joint lifting installation operation simulation scene in an implementation of the disclosure.

FIG. 6 is a schematic diagram of two-dimensional data curves of equipment motion in a jacket skirt pile double-ship joint lifting installation operation simulation scene in an implementation of the disclosure.

### DETAILED DESCRIPTION

In order to make technical solutions and advantage expressions of the disclosure more apparent, specific implementations of the disclosure will be described completely in further detail with reference to the drawings. Each implantation described below is merely a part of exemplary solutions of the disclosure, and is not all implementations. Each implantation described below is intended for explaining the disclosure and shall not be understood as limitation to the disclosure. The reasonable combination of the technical features defined in each implementation of the disclosure, as well as all other implementations obtained by ordinary skill in the art without making creative efforts based on the implementations of the disclosure shall all fall within the protection scope of the disclosure.

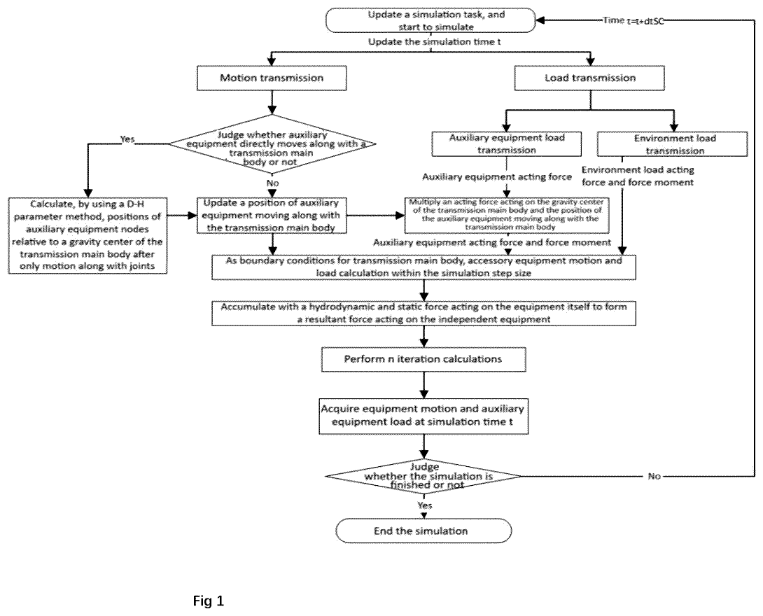

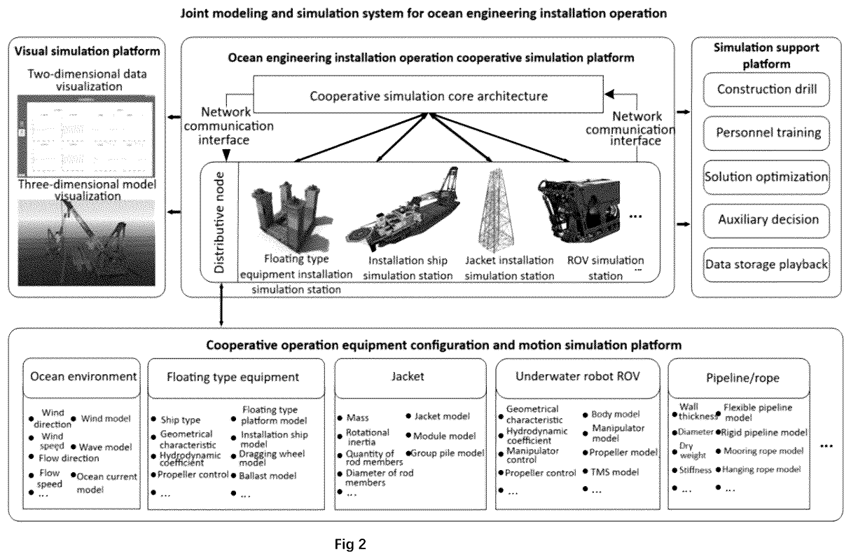

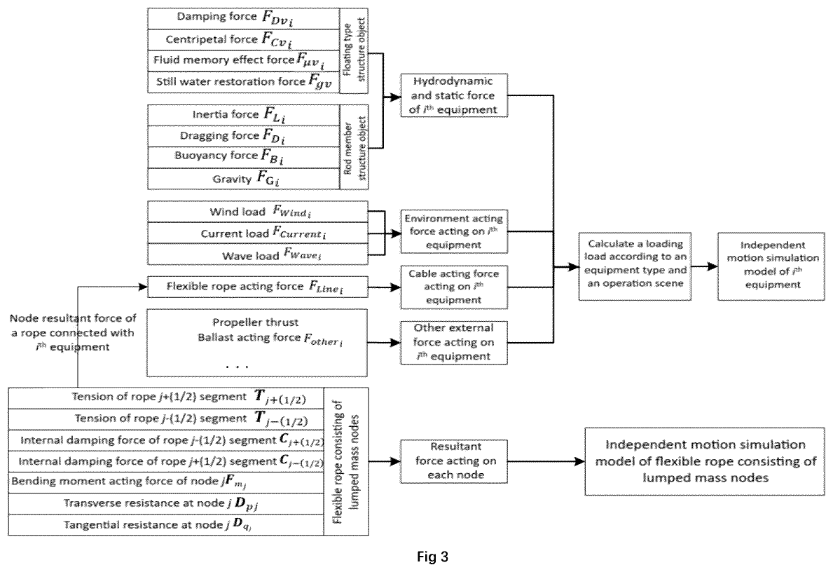

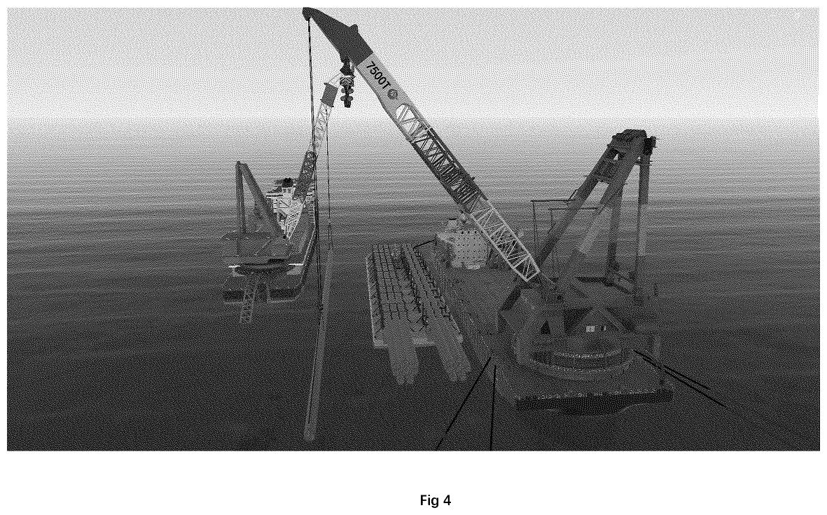

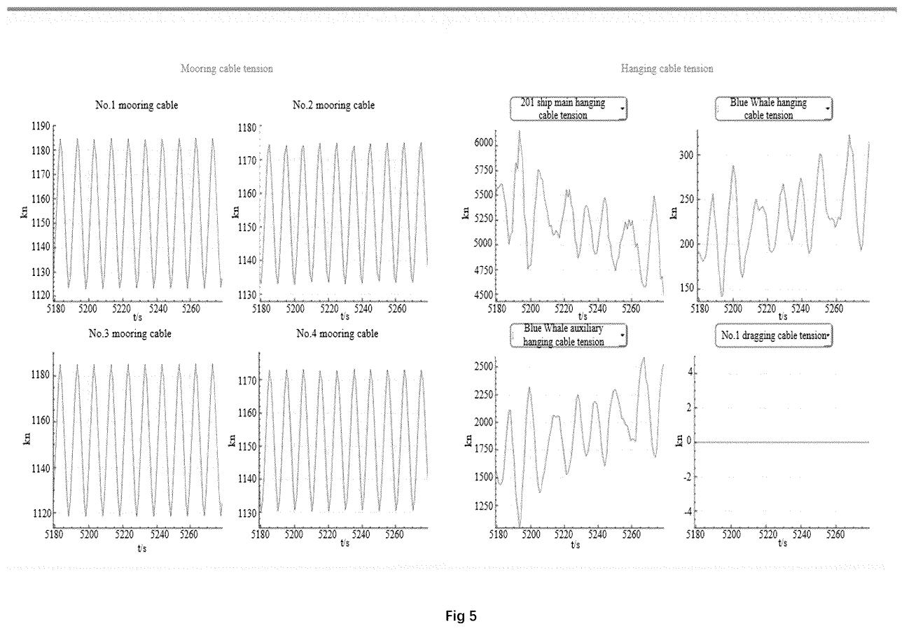

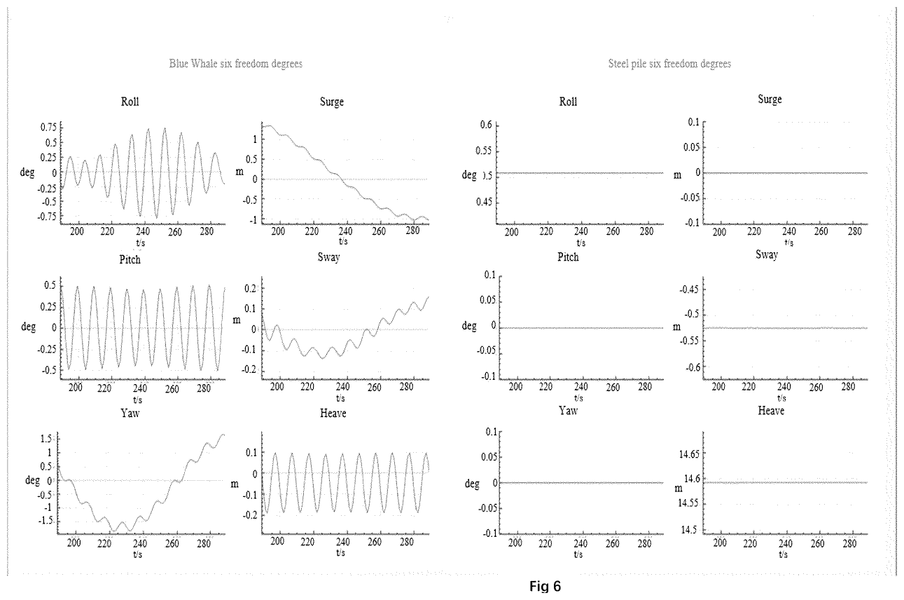

Implementation 1: this implementation is illustrated in combination with FIG. 1 to FIG. 6. This implementation provides a joint modeling and simulation method for ocean engineering installation operation, and the method has the following specific implementation contents:
the method includes the following steps:
Step S1: an equipment independent motion simulation model is acquired by calculating and loading a load acting on each piece of equipment according to an installation operation simulation scene.
Step S2: in given simulation time, the joint simulation real-time data is acquired by using an iteration manner according to the equipment independent motion simulation model. In each iteration, a simulation step size for time advancing is set as dtSC, a solution step size for solving each piece of equipment is set as dtIC, the simulation step size and the solution step size meet dtSC≥dtIC, a multiple relationship between the simulation step size and the solution step size is an integral multiple relationship, or if not an integer multiple relationship, rounded up, the multiple relationship of the simulation step size and the solution step size is used as a number n of iteration steps in a single simulation step size, and n>0; and each iteration includes the following steps:
Step S2.1: global simulation time of this iteration is set as t, and a position of a connection node each piece of equipment at time t is updated through motion transmission simulation.
Step S2.2, connection nodes after position updating are used as boundary conditions in load transmission simulation, and an environment load of each piece of equipment and a load acting force and a force moment of accessory equipment are acquired through load transmission simulation.
Step S2.3: the environment load of each piece of equipment and the load acting force and the force moment of the accessory equipment are substituted into the equipment independent motion simulation model to acquire a resultant force acting on each piece of equipment at the time t in combination with a hydrodynamic and static force acting on each piece of equipment itself.
Step S2.4: in the simulation step size dtSC, an acceleration of the equipment is acquired by classifying the resultant force acting on each piece of equipment at the time t by a mass and inertia moment of each piece of equipment as well as an additional mass and additional inertia moment;
n integration solution is performed by a Runge-Kutta method according to the solution step size dtIC to acquire the joint simulation real-time data of each piece of equipment at time t; and the joint simulation real-time data includes motion of each piece of equipment and a load of the auxiliary equipment.
Step S2.5: whether the iteration is complete is judged:
if the iteration is not complete, the simulation time is updated according to t=t+dtSC, and a next iteration is continuously performed; and
otherwise, the iteration is complete, the simulation method is ended.

In this implementation, whether the iteration is complete may be judged through an external signal. For example, in practical application, the simulation method is implemented by using a simulation system. The simulation system is generally provided with an instructor simulation station, the instructor simulation station is configured to control the completion of the simulation, and the iteration in the simulation is also complete.

Implementation 2: this implementation is illustrated in combination with FIG. 1 to FIG. 6. This implementation further defines the joint modeling and simulation method for ocean engineering installation operation in Implementation 1, and has the following specific implementation contents:
Step S1 includes the following steps:
Step S1.1: an installation simulation basic mathematical model of each piece of equipment is built according to the installation operation simulation scene,

$${\dot{v}}_{i} = \frac{{τ}_{i}}{( {M}_{i} + {M}_{Ai} )}$$

wherein i represents a serial number of the equipment, i∈[1,N], and N is a positive integer; Mᵢ is a mass and inertia moment of the i^{th} equipment; M_{Ai} is an additional mass and additional inertia moment of the i^{th} equipment; τᵢ is a resultant force acting on the i^{th} equipment, \dot{v}_{i=l, n} is a motion acceleration of the i^{th} equipment; and through integral iteration, a motion speed vᵢ and a pose xᵢ of the i^{th} equipment are acquired.
Step S1.2: the resultant force acting on the i^{th} equipment is calculated:

$${τ}_{i} = {\underbrace{{F}_{{HydroStat}_{i}}}}_{Hydrodynamic and static force} + {\underbrace{{F}_{{Wind}_{i}} + {F}_{Curren {t}_{i}} + {F}_{{Wave}_{i}}}}_{Environment acting force} + {\underbrace{{F}_{{Line}_{i}}}}_{Rope acting force} + {\underbrace{{F}_{othe {r}_{i}}}}_{Other external force} ,$$

wherein
F_{Wind}_{ᵢ} is a wind load acting on the i^{th} equipment, F_{Current}_{ᵢ} is a current load acting on the i^{th} equipment, and F_{Wave}_{ᵢ} is a wave load acting on the i^{th} equipment.
Step S1.3: the equipment independent motion simulation model is acquired according to the installation simulation basic mathematical model of each piece of equipment and the resultant force acting thereon.

In this implementation, the resultant force acting on the i^{th} equipment includes three acting forces and force moments in an x direction, a y direction and a z direction of a body-fixed coordinate system of the i^{h} equipment.

In this implementation, the hydrodynamic and static force acting on the i^{th} equipment is distinguished through an equipment type (insulating a floating type structure object and a rod member structure object), and their calculation manners are different:
for example, in the jacket skirt pile double-ship joint lifting installation operation simulation scene, the resultant force of an installation ship, a dynamic positioning ship, a steel pile, a hanging rope and an anchor cable needs to be calculated.

The hydrodynamic and static force of the installation ship (belonging to the floating type structure object) is expressed as follows:

$${F}_{{HydroStat}_{1}} = - {F}_{D {v}_{i}} - {F}_{C {v}_{i}} - {F}_{μ {ν}_{i}} - {F}_{g {v}_{i}} ,$$

where F_{Dv}_{ᵢ} is a damping force; F_{Cv}_{ᵢ} is a centripetal force; F_{μv}_{ᵢ} is a fluid memory effect force; F_{gv}_{ᵢ} is a still water restoration force; F_{Dv}_{ᵢ}=D(vᵢ)vᵢ, and D(vᵢ) is a damping matrix; F_{Cv}_{ᵢ}=C(vᵢ)vᵢ, and C(vᵢ) is a sum of the centripetal force and a geostrophic force matrix; and

$${F}_{μ {v}_{i}} = {\int }_{0}^{t} {K}_{i} ( t - τ ) {\dot{x}}_{i} ( τ ) d τ ,$$

t is simulation time, Kᵢ(t−τ) is a time delay function, and \dot{x}ᵢ(τ) is a unit pulse input; and F_{gv}_{ᵢ}=Gᵢxᵢ, and Gᵢ is a stiffness matrix.

The hydrodynamic and static force of the steel pile (belonging to the rod member structure object) is expressed as follows:

$${F}_{HydroSta {t}_{i}} = {F}_{{L}_{i}} + {F}_{{D}_{i}} + {F}_{{B}_{i}} - {F}_{{G}_{i}} ;$$

and
where F_{L}_{ᵥ} is an inertia force, F_{D}_{ᵢ} is a dragging force, F_{B}_{ᵢ} is a buoyancy force, and F_{G}_{ᵢ} is a gravity.

Implementation 3: this implementation is illustrated in combination with FIG. 1 to FIG. 6. This implementation further defines the joint modeling and simulation method for ocean engineering installation operation in implementation 2, and has the following specific implementation contents:
in Step S1.2, if the i^{th} equipment is a hanging rope or an anchor cable formed by lumped mass nodes, the resultant force acting thereon is acquired by the following method:
modeling is respectively performed on the hanging ropes and anchor cables of different materials, and the resultant force acting on each node is τₑ_{ᵢⱼ}:

$${τ}_{{c}_{l , i}} = {\underbrace{{T}_{{l}_{j + ( 1 / 2 )}} - {T}_{{l}_{j - ( 1 / 2 )}} + {C}_{{l}_{j + ( 1 / 2 )}} - {C}_{{l}_{j - ( 1 / 2 )}} + {F}_{m {l}_{j}}}}_{Internal force of node} + {\underbrace{{D}_{p {l}_{j}} + {D}_{q {l}_{j}} + {W}_{{l}_{j}} + {B}_{{l}_{j}}}}_{Hydrodynamic and static force of node} + {\underbrace{{F}_{other {l}_{j}}}}_{Other external force}$$

where a subscript l represents a serial number of a hanging rope or an anchor cable, l∈[1,f], and f is a total number of the hanging ropes or anchor cables; j represents a serial number of lumped mass nodes in the l^{th} hanging rope or anchor cable, it is supposed that each hanging rope or anchor cable consists of m segments of cables, each hanging rope or anchor cable includes m+1 lumped mass nodes, and j∈[1,m]; Tₗ_{_{j+(1/2)}} is a tension of a [j+(½)]^{th} segment of the l^{th} hanging rope or anchor cable; Tₗ_{_{j−(1/2)}} is a tension of the [j−(½)]^{th} segment of the l^{th} hanging rope or anchor cable; Cₗ_{_{j+(1/2)}} is an internal damping force of the [j+(½)]^{th} segment of the l^{th} hanging rope or anchor cable; Cₗ_{_{j−(1/2)}} is an internal damping force of the [j−(½)]^{th} segment of the l^{th} hanging rope or anchor cable; Fₘₗ_{ⱼ} is a bending moment acting force of the j^{th} lumped mass node of the l^{th} hanging rope or anchor cable; Dₚₗ_{ⱼ} is a transverse resistance force of the l^{th} hanging rope or anchor cable at the j^{th} lumped mass node; D_{ql}_{ⱼ} is a tangential resistance force of the l^{th} hanging rope or anchor cable at the f^{h} lumped mass node; Fₒₜₕₑᵣₗ_{ⱼ}, is other external force acting on the j^{th} lumped mass node of the l^{th} hanging rope or anchor cable;

$${T}_{{l}_{j + ( 1 / 2 )}} = {E}_{l} \frac{π}{4} {d}_{l}^{2} ( \frac{1}{{L}_{{l}_{j}}} - \frac{1}{‖ {r}_{{l}_{j + 1}} - {r}_{{l}_{j}} ‖} ) ( {r}_{{l}_{j + 1}} - {r}_{{l}_{j}} ) ,$$

where Eₗ is a stiffness of the l^{th} hanging rope or anchor cable, dₗ is a diameter of the l^{th} hanging rope or anchor cable, Lₗ_{ⱼ} is a segment length of the j^{th} lumped mass node of the l^{th} hanging rope or anchor cable, and rₗ_{ⱼ₊₁} and rₗ_{ⱼ} are coordinates of the (j+1)^{th} and j^{th} lumped mass nodes of the l^{th} hanging rope or anchor cable;

$${C}_{{l}_{j + ( 1 / 2 )}} = {C}_{i n t l} \frac{π}{4} {d}_{l}^{2} {\dot{ε}}_{{l}_{j + ( 1 / 2 )}} ( \frac{{r}_{{l}_{j + 1}} - {r}_{{l}_{j}}}{‖ {r}_{{l}_{j + 1}} - {r}_{{l}_{j}} ‖} ) ,$$

where Cᵢₙₜₗ is an internal damping coefficient of the l^{th} hanging rope or anchor cable, and \dot{ε}ₗ_{_{j+(1/2)}} is a strain rate; and

$${F}_{m {l}_{j}} = \frac{E {I}_{l} {k}_{{l}_{j}}}{d {l}_{{l}_{j}}} ,$$

where EIₗ is a bending stiffness of the l^{th} hanging rope or anchor cable; and kₗ_{ⱼ} is a curvature in a rₗ_{ⱼ} position, and dlₗ_{ⱼ} is a segment stretched length of the j^{th} lumped mass node of the l^{th} hanging rope or anchor cable.

In this implementation, for the equipment of the hanging rope or the anchor cable consisting of the lumped mass nodes, a calculation manner of the resultant force acting thereon is different from that of other equipment, and the above special processing manner needs to be adopted.

Further, a specific implementation is provided. The jacket skirt pile double-ship joint lifting installation operation simulation scene is taken as an example to illustrate a method for acquiring the equipment independent motion simulation model. The specific content is as follows:
in the simulation process, one anchor moored positioning installation ship (with eight anchor cables), one dynamic positioning ship, one steel pile and two hanging ropes are used for cooperative simulation.

According to the installation operation simulation scene, the load acting on each piece of equipment is calculated and loaded, and the independent motion simulation model of the equipment is acquired. The jacket skirt pile double-ship joint lifting installation operation simulation scene needs the building of the equipment independent motion simulation model of the hanging ropes, the anchor cables, the installation ship, the dynamic positioning ship, and the steel pile;
firstly, an installation simulation basic mathematical model of each piece of equipment is built according to the jacket skirt pile double-ship joint lifting installation operation simulation scene;

$${\dot{v}}_{i} = \frac{{τ}_{i}}{( {M}_{i} + {M}_{Ai} )}$$

through integral iteration, a motion speed vᵢ and a pose xᵢ of the i^{th} equipment is acquired; then, the resultant force τᵢ acting on each equipment is calculated;
for the installation ship, the dynamic positioning ship, and the steel pile, the resultant force acting thereon τᵢ is:

$${τ}_{i} = {\underbrace{\{ \begin{matrix}- {F}_{{Dv}_{i}} - {F}_{{Cv}_{i}} - {F}_{μ {v}_{i}} - {F}_{{gv}_{i}} , \begin{matrix}When {i}^{th} equipment is an installation ship or a dynamic \\ positioning ship\end{matrix} \\ {F}_{{L}_{i}} + {F}_{{D}_{i}} + {F}_{{B}_{i}} - {F}_{{G}_{i}} , When {i}^{th} equipment is a steel pile\end{matrix}}}_{Hydrodynamic and static force} + {\underbrace{{F}_{{Wind}_{i}} + {F}_{{Current}_{i}} + {F}_{{Wave}_{i}}}}_{Environment acting force} + {\underbrace{{F}_{{Line}_{i}}}}_{Rope acting force} + {\underbrace{{F}_{{other}_{i}}}}_{Other external force} ,$$

where F_{Wind}_{ᵢ}, F_{Current}_{ᵢ}, and F_{Wave}_{ᵢ} are environment acting forces considered by the ship and steel pile motion solution;
F_{Line}_{ᵢ} is a cable acting force; and if the i^{th} equipment is provided with no connection cable, F_{Line}_{ᵢ} is 0.

Fₒₜₕₑᵣ_{ᵢ} is other external acting force of a dynamic positioning ship propeller, etc.; and if the i^{th} equipment is entirely above the water, the hydrodynamic force, the wave load and the current load are all 0.

The hanging ropes and anchor cables consisting of the lumped mass nodes are treated as special circumstances, and their resultant force acting is acquired by the following method:
a total number of the hanging ropes or anchor cables is set as 10, i.e., f=10;
   the hanging ropes and anchor cables of different materials are modeled respectively, and the resultant force acting on each lumped mass node is Σₑ_{ᵢⱼ}:

$${τ}_{{c}_{l , i}} = {\underbrace{{T}_{{l}_{j + ( 1 / 2 )}} - {T}_{{l}_{j - ( 1 / 2 )}} + {C}_{{l}_{j + ( 1 / 2 )}} - {C}_{{l}_{j - ( 1 / 2 )}} + {F}_{m {l}_{j}}}}_{Internal force of node} + {\underbrace{{D}_{p {l}_{j}} + {D}_{q {l}_{j}} + {W}_{{l}_{j}} + {B}_{{l}_{j}}}}_{Hydrodynamic and static force of node} + {\underbrace{{F}_{o t h e r {l}_{j}}}}_{Other external force}$$

where Fₒₜₕₑᵣₗ_{ⱼ} is other external force acting on the j^{th} lumped mass node of the l^{th} hanging rope or anchor cable from the anchor gravity.

Finally, the equipment independent motion simulation model is formed according to the above installation simulation basic mathematical model and the calculation and loading method of the resultant force acting on each piece of equipment, and

the independent motion simulation model of the ship (installation ship and dynamic positioning ship) is as follows:

$$( {M}_{i} + {M}_{A i} ) {\dot{v}}_{i} + D ( {v}_{i} ) {v}_{i} + C ( {v}_{i} ) {v}_{i} + {\int }_{0}^{t} {K}_{i} ( t - τ ) {\dot{x}}_{i} ( τ ) d τ + {G}_{i} {x}_{i} = {F}_{Wind i} + {F}_{C u r rent i} + {F}_{Wave i} + {τ}_{cl , j} + {F}_{o ther i}$$

An independent motion simulation model of the steel pile is as follows:

$$( {M}_{i} ) {\dot{v}}_{i} = {F}_{L i} + {F}_{D i} + {F}_{B i} - {F}_{G i} + {F}_{Wind i} + {F}_{Current i} + {F}_{Wave i} + {τ}_{cl , j} + {F}_{o ther i} .$$

An independent motion simulation model of the hanging rope or anchor cable consisting of the lumped mass nodes is as follows:

$$( {M}_{l j} + {M}_{A l j} ) {\ddot{r}}_{l j} = {T}_{l j + ( 1 / 2 )} - {T}_{l j - ( 1 / 2 )} + {C}_{l j + ( 1 / 2 )} - {C}_{lj - ( 1 / 2 )} + {F}_{m l j} + {D}_{{pl}_{j}} + {D}_{{ql}_{j}} + {W}_{{l}_{j}} + {B}_{{l}_{j}} + {F}_{o ther {l}_{j}} .$$

Implementation 4: this implementation is illustrated in combination with FIG. 1 to FIG. 6, and this implementation further defines the joint modeling and simulation method for ocean engineering installation operation in implementation 1, and has the following specific implementation contents:
step S2.1 includes the following steps:
step S2.1.1: equipment in the installation operation simulation scene is classified into a transmission main body and auxiliary equipment, and connection nodes between the auxiliary equipment and the transmission main body are determined; the connection nodes are classified into nodes directly moving along with the transmission main body, and nodes restrained by an equipment operation range for indirectly moving along with the transmission main body;
step S2.1.2: for the nodes directly moving along with the transmission main body:
the positions of the nodes are calculated and updated in accordance with a Euler angle, a rotation sequence and an external rotation manner according to the motion of the transmission main body at the time t to acquire the positions of the nodes directly moving along with the transmission main body at the time t; and
step S2.1.3: for the nodes restrained by an equipment operation range for indirectly moving along with the transmission main body:
the positions of the nodes relative to a gravity center of the transmission main body at the time t are calculated and updated through calculation according to a D-H parameter method without considering the motion of the transmission main body at the time t but only considering the restraint on the nodes by the equipment operation range; and
the positions of the nodes are calculated and updated according to the positions of the nodes relative to the gravity center of the transmission main body at the time t in accordance with the Euler angle, the rotation sequence, the external rotation manner, and the motion of the transmission main body at the time t to acquire the positions of the nodes restrained by an equipment operation range for indirectly moving along with the transmission main body at the time t.

Further, a specific implementation is provided, the motion transmission simulation is illustrated by taking the jacket skirt pile double-ship joint lifting installation operation simulation scene as an example, and the specific content is as follows:
through motion transmission simulation, positions of crane vertexes, anchor cable fairleads and hanging rope connection points (i.e., connection nodes) moving along with the ship body and the steel pile are updated:
firstly, the installation ship, the dynamic positioning ship, and the steel pile are regarded as the transmission main body; the hanging ropes and the anchor cables are regarded as the auxiliary equipment; and the confirmation of the connection nodes is as follows:
0^{th} nodes of hanging ropes with serial numbers 1 and 2 are connected with the steel pile, and
m^{th} nodes are respectively connected with a crane on the ship body; m^{th} nodes of anchor cables with serial numbers 3 to 10 are respectively and directly connected with the ship body, i.e., the connection nodes r_{l=1 j=0}, r_{l=2 j=0}, r_{l=1 j=m}, r_{l=2 j=m}, and r_{l=3,10 j=m} move along with the transmission main body, r_{l=1 j=0}, r_{l=2 j=0} and r_{l=3,10 j=m} are nodes directly moving along with the transmission main body, and r_{l=1 j=0} and r_{l=2 j=0} are nodes restrained by a crane operation range for indirectly moving along with the transmission main body;
then, for the nodes r_{l=1 j=0}, r_{l=2 j=0} and r_{l=3,10 j=m}, their positions at the time t are calculated and updated in accordance with a Euler angle, a rotation sequence x→y→z and an external rotation manner; and
finally, for r_{l=1 j=0} and r_{l=2 j=0}:
firstly, the positions of connection points of the hanging ropes and the crane relative to a gravity center of the installation ship are calculated through calculation according a D-H parameter method without considering the motion of the installation ship but only considering the motion of the hanging ropes along with crane joints; and
then, the positions of the nodes r_{l=1 j=0} and r_{l=2 j=0} at the time t are calculated and updated according to the Euler angle, the rotation sequence x→y→z and the external rotation manner.

Implementation 5: this implementation is illustrated in combination with FIG. 1 to FIG. 6, this implementation further defines the joint modeling and simulation method for ocean engineering installation operation in Implementation 1, and has the following specific implementation contents:
Step S2.3 includes the following steps:
Step S2.3.1: the load transmission simulation is classified into environment load transmission and accessory equipment load transmission;
Step S2.3.2: for the environment load transmission:
environment load acting forces and force moments acting along an x-axis, a y-axis and a z-axis of a body-fixed coordinate system at the gravity center of the transmission main body are acquired according to the hydrodynamic characteristics of the transmission main body and the six-freedom-degree motion calculation of the transmission main body; and
Step S2.3.3: for the auxiliary equipment load transmission:
connection nodes after position updating are used as boundary conditions;
an acting force of the connection nodes relative to the gravity center of the transmission main body, and positions of the connection nodes relative to the gravity center of the transmission main body are acquired according to the equipment independent motion simulation model; and
the acting force of the connection nodes relative to the gravity center of the transmission main body and the positions of the connection nodes relative to the gravity center of the transmission main body are multiplied to acquire the load acting force and the force moment of the auxiliary equipment acting along the x-axis, the y-axis and the z-axis of the body-fixed coordinate system at the gravity center of the transmission main body.

Further, a specific implementation is provided. The load transmission simulation is illustrated by taking the jacket skirt pile double-ship joint lifting installation operation simulation scene as an example. The specific content is as follows:
the load transmission simulation is classified into environment load transmission and auxiliary equipment load transmission of the anchor cables, hanging cables, etc.
through motion transmission simulation, positions of crane vertexes, anchor cable fairleads and hanging rope connection points moving along with the ship body and the steel pile are updated;
(the positions of) the connection nodes after the position updating are used as boundary conditions for calculating the hanging rope and anchor cable load (i.e., auxiliary equipment load) calculation; specifically:
firstly, r_{l=1 j=0}, r_{l=2 j=0}, r_{l=1 j=m}, r_{l=2 j=m}, and r_{l=3,10 j=m} are used as boundary conditions for calculating the hanging rope and anchor cable data \ddot{r}ₗⱼ and load data T_{lj+(1/2)}, C_{lj+(1/2)}, and Bᵢⱼ within the simulation step size, the cable acting force τ_{el,j} is acquired, and is used for load transmission;
then, for the environment load transmission:
environment load acting forces and force moments acting along an x-axis, a y-axis and a z-axis of a body-fixed coordinate system at the gravity center of the transmission main body are acquired according to the hydrodynamic characteristics of the transmission main body and the six-freedom-degree motion calculation of the transmission main body;
then, for the auxiliary equipment load transmission, i.e., the load transmission process of the anchor cables and the hanging cables:
according to an flexible rope independent motion simulation model consisting of the lumped mass nodes, the acting force Σ_{el=1: j=0} at the 0^{th} lumped mass node of the hanging rope with serial number 1 relative to the gravity center of the steel pile, and the position (rₓ_{₀}_{l=1,j=0′}, r_{y}_{₀}_{l=1,j=0′}, r_{z}_{₀}_{l=1,j=0}) of the hanging rope connection position relative to the gravity center of the steel pile are acquired through calculation;
τ_{cl=1; j=0} and (rₓ_{₀}_{l=1,j=0′}, r_{y}_{₀}_{l=1,j=0′}, r_{z}_{₀}_{l=1,j=0}) are multiplied, and the load acting force and the force moment of the auxiliary equipment acting on the x-axis, y-axis and z-axis directions of the body-fixed coordinate system at the gravity center of the steel pile are acquired through combination:

$${τ}_{cl , j} = [ {τ}_{cl , 0} ( 0 ) , {τ}_{cl , 0} ( 1 ) , {τ}_{cl , 0} ( 2 ) , {τ}_{cl , 0} ( 2 ) * {r}_{{y}_{0} l , 0} - {τ}_{cl , 0} ( 1 ) * {r}_{{z}_{0} l , 0} , {τ}_{cl , 0} ( 0 ) * {r}_{{z}_{0} l , 0} - {τ}_{cl , 0} ( 2 ) * {r}_{{x}_{0} l , 0} , {τ}_{cl , 0} ( 1 ) * {r}_{{x}_{0} l , 0} - {τ}_{cl , 0} ( 0 ) * {r}_{{y}_{0} l , 0} ]$$

the process of other auxiliary equipment load transmission, such as the load transmission of the 0^{th} lumped mass node of the hanging rope with serial number 2 and the steel pile, the m^{th} lumped mass node of the hanging rope with serial number 1 or 2 and the ship, and the m^{th} lumped mass nodes of the anchor cables with serial numbers 3 to 10 and the ship is as the above and
finally, the environment load and the load acting force and force moments of auxiliary equipment such as the anchor cables and hanging ropes are substituted into the equipment independent motion simulation model of the transmission main body within the simulation step size for summation with the hydrodynamic and static force acting on the equipment itself to form the resultant force τᵢ acting on the equipment.

Implementation 6: this implementation is illustrated in combination with FIG. 1 to FIG. 6. This implementation provides a joint modeling and simulation system for ocean engineering installation operation, and has the following specific implementation contents:
the system includes: a cooperative operation equipment configuration and motion simulation platform, an ocean engineering installation operation cooperative simulation platform, a simulation support platform and a plurality of simulation stations;
the ocean engineering installation operation cooperative simulation platform includes a distributive cooperative simulation core framework; the distributive cooperative simulation core framework, as a central control node, is connected with the plurality of simulation stations through network communication, and is configured to provide a data communication interface and resource allocation and scheduling according to the installation operation simulation scene and control a simulation progress;
each simulation station is used as a distributive node and is configured to provide semi-physical simulation equipment;
the cooperative operation equipment configuration and motion simulation platform is configured to provide an equipment installation operation joint simulation model framework applicable to a floating structure, a rod member structure and a hanging rope and anchor cable consisting of lumped mass nodes;
the equipment installation operation joint simulation model framework is configured to build an equipment independent motion simulation model according to an equipment type in the installation operation simulation scene by using the above joint modeling and simulation method for ocean engineering installation operation, perform integrated simulation through motion transmission and load transmission, and reuse and share the equipment independent motion simulation model to acquire joint simulation real-time data; and
the simulation support platform is configured to be connected with the simulation stations required by the installation operation simulation scene according to the data communication interface and resource allocation and scheduling provided by the ocean engineering installation operation cooperative simulation platform, and call the required semi-physical simulation equipment and the equipment independent motion simulation model to complete the simulation in the installation operation simulation scene.

In this implementation, the equipment independent motion simulation model belongs to a mathematical calculation model.

In this implementation, the calculated and loaded load includes the hydrodynamic and static force acting on the equipment, the environment acting force, the rope acting force and other external force.

In this implementation, the plurality of simulation stations are simulation operation stations of each simulation object included in the installation operation simulation scene. The simulation operation station generally refers to a special operation position or station set for an operator or a user in an emulation or simulation environment. The design of this type of station aims at enabling the operator to be in a safe environment similar to the reality to perform various operations, tests or trains for skill, response or decision ability evaluation. The simulation operation station is generally provided with necessary hardware and software equipment to simulate various conditions and circumstances in the practical operation environment. For example, in the field of ocean engineering, the simulation operation station simulates a cockpit of the ship, including a propeller, a steering engine, an anchor winch console and other equipment related to navigation, so that a seaman can do navigation train in the simulation environment.

In this implementation, semi-physical simulation equipment is also called as physical-mathematical simulation or semi-physical-entity simulation equipment, and belongs to a system real-time simulation method. In this method, a part of a simulated object system is introduced into a simulation loop in a manner of a physical entity (or physical model), other parts of the simulated object system are described by a mathematical model, and are converted into a simulation calculation model (i.e., equipment independent motion simulation model). By using a physical effect model, the joint simulation of real-time mathematical simulation and physical simulation is performed. The semi-physical simulation equipment generally consists of a simulation computer meeting the real-time requirement, a motion simulator, a target simulator, a console and some physical entities. Its fidelity is high, so it is generally used for verifying the correctness and feasibility of the control system solution, performing fault mode simulation, and performing closed-circuit dynamic acceptance tests on control systems at each development stage.

Implementation 7: this implementation is illustrated in combination with FIG. 1 to FIG. 6. This implementation further defines the joint modeling and simulation system for ocean engineering installation operation in Implementation 6, and has the following specific implementation contents:
the system further includes a visual simulation platform;
the visual simulation platform includes a two-dimensional data visual module and a three-dimensional model visual module;
the three-dimensional model visual module is configured to receive the joint simulation real-time data generated by the cooperative operation equipment configuration and motion simulation platform according to the data communication interface and resource allocation and scheduling provided by the ocean engineering installation operation cooperative simulation platform, and drive a three-dimensional model in a visual three-dimensional image to run according to the joint simulation real-time data; and
the two-dimensional data visual module is configured to receive the joint simulation real-time data generated by the cooperative operation equipment configuration and motion simulation platform according to the data communication interface and resource allocation and scheduling provided by the ocean engineering installation operation cooperative simulation platform, and display the joint simulation real-time data into a two-dimensional data curve in a visual two-dimensional image.

In this implementation, the visual three-dimensional image is built by the three-dimensional model visual module. The three-dimensional model in the visual three-dimensional image is a three-dimensional model for the simulation equipment built by the three-dimensional model visual module by using a modeling software.

In this implementation, the visual two-dimensional image is built by the two-dimensional data visual module.

Implementation 8: this implementation is illustrated in combination with FIG. 1 to FIG. 6. This implementation further defines the joint modeling and simulation system for ocean engineering installation operation in Implementation 6, and has the following specific implementation contents:
the plurality of simulation stations include a floating type equipment installation simulation station, an installation ship simulation station, a jacket installation simulation station, an underwater robot simulation station, a dome screen view simulation station and a crane simulation station.

In this implementation, the plurality of simulation stations further include an instructor simulation station.

Implementation 9: this implementation is illustrated in combination with FIG. 1 to FIG. 6. This implementation further defines the joint modeling and simulation system for ocean engineering installation operation in Implementation 6, and has the following specific implementation contents:
the simulation support platform includes a construction drill module and a personnel training module;
the construction drill module is configured to be connected with the simulation stations required by the construction drill simulation scene according to the data communication interface and resource allocation and scheduling provided by the ocean engineering installation operation cooperative simulation platform, and call the required semi-physical simulation equipment and the equipment independent motion simulation model to complete the simulation in the construction drill simulation scene; and
the personnel training module is configured to be connected with the simulation stations required by the personnel training simulation scene according to the data communication interface and resource allocation and scheduling provided by the ocean engineering installation operation cooperative simulation platform, and call the required semi-physical simulation equipment and the equipment independent motion simulation model to complete the simulation in the personnel training simulation scene.

Implementation 10: this implementation is illustrated in combination with FIG. 1 to FIG. 6. This implementation further defines the joint modeling and simulation system for ocean engineering installation operation in Implementation 6, and has the following specific implementation contents:
the simulation support platform further includes a data storage module; and
the data storage module is configured to store the joint simulation real-time data generated by the cooperative operation equipment configuration and motion simulation platform according to the data communication interface and resource allocation and scheduling provided by the ocean engineering installation operation cooperative simulation platform.

Further, an exemplary implementation is provided. The simulation support platform further includes a solution optimization module, an auxiliary decision module and a playback function module;
the solution optimization module is configured to optimize the construction solution of the installation operation simulation scene according to the joint simulation real-time data stored by the data storage module;
the auxiliary decision module is configured to provide a decision auxiliary basis for construction personnel according to the joint simulation real-time data stored in the data storage module and the three-dimensional scene provided by the visual simulation platform; and
the playback function module is configured to provide a three-dimensional scene and two-dimensional data playback function by using the visual simulation platform according to the joint simulation real-time data stored in the data storage module.

Further, a specific implementation is provided. The jacket skirt pile double-ship joint lifting installation operation simulation scene is taken as an example to illustrate the use of the joint modeling and simulation system for ocean engineering installation operation. The specific content is as follows:
firstly, an ocean engineering installation operation cooperative simulation platform consisting of a central control node and a plurality of simulation nodes (i.e., a plurality of simulation stations) is built by using a distributive method.

Then, according to the jacket skirt pile double-ship joint lifting installation operation simulation scene, the simulation nodes (i.e., resource allocation and scheduling) are planned, including:
a jacket skirt pile installation simulation station, respectively performing steel pile and hanging rope motion response calculation; an installation ship simulation station, respectively performing anchoring positioning installation ship and anchor cable motion response calculation; a dynamic positioning ship simulation station, performing dynamic positioning ship motion response calculation; a crane simulation station, respectively performing installation ship and dynamic positioning ship crane operation; an instructor simulation station, performing subject issuing and data recording and analysis; and a dome screen view simulation station, performing three-dimensional view display.

The ocean engineering installation operation cooperative simulation platform allocates a data communication interface for each simulation node.

Then, according to the jacket skirt pile double-ship joint lifting installation operation simulation scene, the steel pile, the hanging ropes, the installation ship, the anchor cables, and the dynamic positioning ship are used as joint simulation equipment. In the cooperative operation equipment configuration and motion simulation platform, according to the jacket skirt pile double-ship joint lifting installation operation simulation scene, the load acting on each joint simulation is calculated and loaded to form the equipment independent motion simulation model.

Next, the simulation method is used for simulation, and the equipment motion and auxiliary equipment load at the time t are acquired.

Next, based on the ocean engineering installation operation cooperative simulation platform and its allocated data communication interface, the acquired equipment motion and auxiliary equipment load at the time t are synchronously provided for the visual simulation platform and the simulation support platform for two-dimensional data display, three-dimensional model driving and simulation data analysis.

The above further detailed descriptions on the technical solution provided by the disclosure through several specific implementations are intended to highlight the advantages and benefits of the technical solution provided by the disclosure. However, the above specific implementations are not intended to limit the disclosure. Any reasonable changes and improvements to the disclosure, reasonable combinations and equivalent substitutions of implementations, and the like within the scope of the spirit and principles of the disclosure shall all fall within the protection scope of the disclosure.

What is claimed is:

1. A joint modeling and simulation method for ocean engineering installation operation, comprising the following steps:
step S1: acquiring an equipment independent motion simulation model by calculating and loading a load acting on each piece of equipment according to an installation operation simulation scene; and
step S2: in given simulation time, acquiring joint simulation real-time data by using an iteration manner according to the equipment independent motion simulation model, wherein in each iteration, a simulation step size for time advancing is set as dtSC, a solution step size for solving each piece of equipment is set as dtIC, the simulation step size and the solution step size meet dtSC≥dtIC, a multiple relationship between the simulation step size and the solution step size is an integral multiple relationship, or if not an integer multiple relationship, rounded up, the multiple relationship of the simulation step size and the solution step size is used as a number n of iteration steps in a single simulation step size, and n>0; and each iteration comprises the following steps:
step S2.1: setting global simulation time of this iteration to be t, and updating a position of a connection node each piece of equipment at time t through motion transmission simulation;
step S2.2, using connection nodes after position updating as boundary conditions in load transmission simulation, and acquiring an environment load of each piece of equipment and a load acting force and a force moment of accessory equipment through load transmission simulation;
step S2.3: substituting the environment load of each piece of equipment and the load acting force and the force moment of the accessory equipment into the equipment independent motion simulation model to acquire a resultant force acting on each piece of equipment at the time t in combination with a hydrodynamic and static force acting on each piece of equipment itself;
step S2.4: in simulation step size dtSC, acquiring an acceleration of the equipment by classifying the resultant force acting on each piece of equipment at the time t by a mass and inertia moment of each piece of equipment as well as an additional mass and additional inertia moment; and
performing n integration solution by a Runge-Kutta method according to the solution step size dtIC to acquire the joint simulation real-time data of each piece of equipment at time t, wherein the joint simulation real-time data comprises motion of each piece of equipment and a load of auxiliary equipment;
step S2.5: judging whether the iteration is complete:
if the iteration is not complete, updating the simulation time according to t=t+dtSC, and continuously performing a next iteration; and
otherwise, the iteration is complete, ending the simulation method.

2. The joint modeling and simulation method for ocean engineering installation operation according to claim 1, wherein step S1 comprises the following steps:
step S1.1: building an installation simulation basic mathematical model of each piece of equipment according to the installation operation simulation scene,
$${\dot{v}}_{i} = \frac{{τ}_{i}}{( {M}_{i} + {M}_{Ai} )}$$
wherein i represents a serial number of the equipment, i∈[1,N], and N is a positive integer; Mᵢ is a mass and inertia moment of the i^{th} equipment; M_{Ai} is an additional mass and additional inertia moment of the i^{th} equipment; τᵢ is a resultant force acting on the i^{th} equipment, \dot{v}_{i=l, n} is a motion acceleration of the i^{th} equipment; and
through integral iteration, acquiring a motion speed vᵢ and a pose xᵢ of the i^{th} equipment;
step S1.2: calculating the resultant force acting on the i^{th} equipment:
$${τ}_{i} = {\underbrace{{F}_{{HydroStat}_{i}}}}_{Hydrodynamic and static force} + {\underbrace{{F}_{{Wind}_{i}} + {F}_{{Current}_{i}} + {F}_{{Wave}_{i}}}}_{Environment acting force} + {\underbrace{{F}_{{Line}_{i}}}}_{Rope acting force} + {\underbrace{{F}_{{other}_{i}}}}_{Other external force} ,$$
wherein F_{Wind}, is a wind load acting on the i^{th} equipment, F_{Current} is a current load acting on the i^{th} equipment, and F^{Wave}, is a wave load acting on the i^{th} equipment; and
step S1.3: acquiring the equipment independent motion simulation model according to the installation simulation basic mathematical model of each piece of equipment and the resultant force acting thereon.

3. The joint modeling and simulation method for ocean engineering installation operation according to claim 2, wherein in step S1.2, if the i^{th} equipment is a hanging rope or an anchor cable formed by lumped mass nodes, the resultant force acting thereon is acquired by the following method:
respectively modeling the hanging ropes and anchor cables of different materials, and regarding the resultant force acting on each node as τₑ_{_{i,j}}:
$${τ}_{{c}_{l , i}} = {\underbrace{{T}_{{l}_{j + ( 1 / 2 )}} - {T}_{{l}_{j - ( 1 / 2 )}} + {C}_{{l}_{j + ( 1 / 2 )}} - {C}_{{l}_{j - ( 1 / 2 )}} + {F}_{m {l}_{j}}}}_{Internal force of node} + {\underbrace{{D}_{p {l}_{j}} + {D}_{q {l}_{j}} + {W}_{{l}_{j}} + {B}_{{l}_{j}}}}_{Hydrodynamic and static force of node} + {\underbrace{{F}_{o t h e r {l}_{j}}}}_{Other external force} ,$$
wherein a subscript l represents a serial number of a hanging rope or an anchor cable, l∈[1,f], and f is a total number of the hanging ropes or anchor cables; j represents a serial number of lumped mass nodes in the l^{th} hanging rope or anchor cable, it is supposed that each hanging rope or anchor cable consists of m segments of cables, each hanging rope or anchor cable comprises m+1 lumped mass nodes, and j∈[1,m]; Tₗ_{_{j+(1/2)}} is a tension of a [j+(½)]^{th} segment of the l^{th} hanging rope or anchor cable; Tₗ_{_{j−(1/2)}} is a tension of the [j−(½)]^{th} segment of the l^{th} hanging rope or anchor cable; Cₗ_{_{j+(1/2)}} is an internal damping force of the [j+(½)]^{th} segment of the l^{th} hanging rope or anchor cable; Tₗ_{_{j−(1/2)}} is an internal damping force of the [j+(½)]^{th} segment of the l^{th} hanging rope or anchor cable; Fₘₗ_{ⱼ} is a bending moment acting force of the j^{th} lumped mass node of the l^{th} hanging rope or anchor cable; Dₚₗ_{ⱼ} is a transverse resistance force of the l^{th} hanging rope or anchor cable at the j^{th} lumped mass node; D_{ql}_{ⱼ} is a tangential resistance force of the l^{th} hanging rope or anchor cable at the j^{th} lumped mass node; Fₒₜₕₑᵣₗ_{ⱼ} is other external force acting on the j^{th} lumped mass node of the l^{th} hanging rope or anchor cable;
$${T}_{{l}_{j + ( 1 / 2 )}} = {E}_{l} \frac{π}{4} {d}_{l}^{2} ( \frac{1}{{L}_{{l}_{j}}} - \frac{1}{‖ {r}_{{l}_{j + 1}} - {r}_{{l}_{j}} ‖} ) ( {r}_{{l}_{j + 1}} - {r}_{{l}_{j}} ) ,$$
wherein Eₗ is a stiffness of the l^{th} hanging rope or anchor cable, dₗ is a diameter of the l^{th} hanging rope or anchor cable, Lₗ_{ⱼ} is a segment length of the j^{th} lumped mass node of the l^{th} hanging rope or anchor cable, and rₗ_{ⱼ₊₁} and rₗ_{ⱼ} are coordinates of the (j+1)^{th} and j^{th} lumped mass nodes of the l^{th} hanging rope or anchor cable;
$${C}_{{l}_{j + ( 1 / 2 )}} = {C}_{i n t l} \frac{π}{4} {d}_{l}^{2} {\dot{ε}}_{{l}_{j + ( 1 / 2 )}} ( \frac{{r}_{{l}_{j + 1}} - {r}_{{l}_{j}}}{‖ {r}_{{l}_{j + 1}} - {r}_{{l}_{j}} ‖} ) ,$$
wherein C_{intI}, is an internal damping coefficient of the l^{th} hanging rope or anchor cable, and \dot{ε}ₗ_{_{j+(1/2)}} is a strain rate; and
$${F}_{m {l}_{j}} = \frac{E {I}_{l} {k}_{{l}_{j}}}{d {l}_{{l}_{j}}} ,$$
wherein EIₗ is a bending stiffness of the l^{th} hanging rope or anchor cable; and kₗ_{ⱼ} is a curvature in a rₗ_{ⱼ} position, and dlₗ_{ⱼ} is a segment stretched length of the j^{th} lumped mass node of the l^{th} hanging rope or anchor cable.

4. The joint modeling and simulation method for ocean engineering installation operation according to claim 1, wherein step S2.1 comprises the following steps:
step S2.1.1: classifying equipment in the installation operation simulation scene into a transmission main body and auxiliary equipment, and determining connection nodes between the auxiliary equipment and the transmission main body; classifying the connection nodes into nodes directly moving along with the transmission main body, and nodes restrained by an equipment operation range for indirectly moving along with the transmission main body;
step S2.1.2: for the nodes directly moving along with the transmission main body:
calculating and updating the positions of the nodes in accordance with a Euler angle, a rotation sequence and an external rotation manner according to the motion of the transmission main body at the time t to acquire the positions of the nodes directly moving along with the transmission main body at the time t; and
step S2.1.3: for the nodes restrained by an equipment operation range for indirectly moving along with the transmission main body:
calculating and updating the positions of the nodes relative to a gravity center of the transmission main body at the time t through calculation according to a D-H parameter method without considering the motion of the transmission main body at the time t but only considering restraint on the nodes by the equipment operation range; and
calculating and updating the positions of the nodes according to the positions of the nodes relative to the gravity center of the transmission main body at the time t in accordance with the Euler angle, the rotation sequence, the external rotation manner, and the motion of the transmission main body at the time t to acquire the positions of the nodes restrained by an equipment operation range for indirectly moving along with the transmission main body at the time t.

5. The joint modeling and simulation method for ocean engineering installation operation according to claim 1, wherein step S2.3 comprises the following steps:
step S2.3.1: classifying the load transmission simulation into environment load transmission and accessory equipment load transmission;
step S2.3.2: for the environment load transmission:
acquiring environment load acting forces and force moments acting along an x-axis, a y-axis and a z-axis of a body-fixed coordinate system at the gravity center of a transmission main body according to the hydrodynamic characteristics of the transmission main body and the six-freedom-degree motion calculation of the transmission main body; and
step S2.3.3: for an auxiliary equipment load transmission:
using connection nodes after position updating as boundary conditions;
acquiring an acting force of the connection nodes relative to the gravity center of the transmission main body, and positions of the connection nodes relative to the gravity center of the transmission main body according to the equipment independent motion simulation model; and
multiplying the acting force of the connection nodes relative to the gravity center of the transmission main body and the positions of the connection nodes relative to the gravity center of the transmission main body to acquire the load acting force and the force moment of the auxiliary equipment acting along the x-axis, the y-axis and the z-axis of the body-fixed coordinate system at the gravity center of the transmission main body.

6. A joint modeling and simulation system for ocean engineering installation operation, comprising: a cooperative operation equipment configuration and motion simulation platform, an ocean engineering installation operation cooperative simulation platform, a simulation support platform and a plurality of simulation stations, wherein the ocean engineering installation operation cooperative simulation platform comprises a distributive cooperative simulation core framework; the distributive cooperative simulation core framework, as a central control node, is connected with the plurality of simulation stations through network communication, and is configured to provide a data communication interface and resource allocation and scheduling according to the installation operation simulation scene and control a simulation progress;
each simulation station is used as a distributive node and is configured to provide semi-physical simulation equipment;
the cooperative operation equipment configuration and motion simulation platform is configured to provide an equipment installation operation joint simulation model framework applicable to a floating structure, a rod member structure and a hanging rope and anchor cable consisting of lumped mass nodes;
the equipment installation operation joint simulation model framework is configured to build an equipment independent motion simulation model according to an equipment type in the installation operation simulation scene by using the joint modeling and simulation method for ocean engineering installation operation according to any one of claims 1 to 5, perform integrated simulation through motion transmission and load transmission, and reuse and share the equipment independent motion simulation model to acquire joint simulation real-time data; and
the simulation support platform is configured to be connected with the simulation stations required by the installation operation simulation scene according to the data communication interface and resource allocation and scheduling provided by the ocean engineering installation operation cooperative simulation platform, and call required semi-physical simulation equipment and the equipment independent motion simulation model to complete the simulation in the installation operation simulation scene.

7. The joint modeling and simulation system for ocean engineering installation operation according to claim 6, further comprising a visual simulation platform, wherein
the visual simulation platform comprises a two-dimensional data visual module and a three-dimensional model visual module;
the three-dimensional model visual module is configured to receive the joint simulation real-time data generated by the cooperative operation equipment configuration and motion simulation platform according to the data communication interface and resource allocation and scheduling provided by the ocean engineering installation operation cooperative simulation platform, and drive a three-dimensional model in a visual three-dimensional image to run according to the joint simulation real-time data; and
the two-dimensional data visual module is configured to receive the joint simulation real-time data generated by the cooperative operation equipment configuration and motion simulation platform according to the data communication interface and resource allocation and scheduling provided by the ocean engineering installation operation cooperative simulation platform, and display the joint simulation real-time data into a two-dimensional data curve in a visual two-dimensional image.

8. The joint modeling and simulation system for ocean engineering installation operation according to claim 6, wherein the plurality of simulation stations comprises a floating type equipment installation simulation station, an installation ship simulation station, a jacket installation simulation station, an underwater robot simulation station, a dome screen view simulation station and a crane simulation station.

9. The joint modeling and simulation system for ocean engineering installation operation according to claim 6, wherein the simulation support platform comprises a construction drill module and a personnel training module;
the construction drill module is configured to be connected with the simulation stations required by a construction drill simulation scene according to the data communication interface and resource allocation and scheduling provided by the ocean engineering installation operation cooperative simulation platform, and call the required semi-physical simulation equipment and the equipment independent motion simulation model to complete the simulation in the construction drill simulation scene; and
the personnel training module is configured to be connected with the simulation stations required by the personnel training simulation scene according to the data communication interface and resource allocation and scheduling provided by the ocean engineering installation operation cooperative simulation platform, and call the required semi-physical simulation equipment and the equipment independent motion simulation model to complete the simulation in the personnel training simulation scene.

10. The joint modeling and simulation system for ocean engineering installation operation according to claim 9, wherein the simulation support platform further comprises a data storage module, wherein
the data storage module is configured to store the joint simulation real-time data generated by the cooperative operation equipment configuration and motion simulation platform according to the data communication interface and resource allocation and scheduling provided by the ocean engineering installation operation cooperative simulation platform.
